(19) United States
(12) Patent Application Publication
(10) Pub. No.: US 2023/0331502 A1
(43) Pub. Date: Oct. 19, 2023

(54) LABEL HOLDER FOR CARTS

(71) Applicant: Andrew Clark Turner, Knoxville, TN (US)

(72) Inventor: Andrew Clark Turner, Knoxville, TN (US)

(21) Appl. No.: 17/659,593

(22) Filed: Apr. 18, 2022

(51) Int. Cl. B65H 18/02; B62B 3/00; B62B 3/02; B62B 3/14

(52) U.S. Cl. CPC B65H 18/021; B62B 3/005; B62B 3/02; B62B 3/146; B62B 3/1468

(57) ABSTRACT

A label holder for a cart is herein disclosed. The cart includes a cart frame, a cart hanging hook supported by the cart frame, and a slotted bar supported by the cart frame. The label holder includes a main body and an orientation block. The main body includes a front end, a rear end, and dividing walls. The dividing walls each define a label slot which is designed to receive a label spool. Each dividing wall defines a hanger hole through which the cart hanging hook passes. The orientation block projects rearwardly from the rear end of the main body and engages the slotted bar of the cart, in use.

### BACKGROUND OF THE INVENTION

The present invention relates to label holders and, more particularly, to a label management device for carts.

Currently, specialty carts are provided at businesses for various purposes, such as to fulfill online grocery orders. In conjunction with such tasks, labels are often used. Labels are typically provided on a large spool, which has a tendency to get unspooled and tangled.

Specialty carts like these often retain label spools for easy access by the employees while they're carrying out their tasks (e.g., picking up groceries). The current solution is an open-ended pivoting bar where labels spools are held. Since the bar has no stop, spools fall off easily. Spools also unspool themselves when hanging on this bar. Spools frequently getting knocked off the cart results in a waste of the labels and a general loss in productivity due to time spent re-spooling or locating missing spools of labels.

As can be seen, there is a need for a label management device for carts as described herein.

### SUMMARY OF THE INVENTION

In one aspect of the present invention, a label holder for a cart is provided, with the label holder comprising: a main body comprising a front end, a rear end, and a plurality of dividing walls, with the plurality of dividing walls defining a plurality of label slots, with each of the plurality of label slots being configured to receive a label spool, and with each dividing wall of the plurality of dividing walls defining a hanger hole configured to have a cart hanging hook pass therethrough; and an orientation block projecting rearwardly from the rear end of the main body, the orientation block being configured to engage a slotted bar of the cart.

In another aspect of the present invention, a label holder system is provided, with the label holder system comprising: a cart comprising a cart frame, a cart hanging hook supported by the cart frame, and a slotted bar supported by the cart frame; a plurality of label spools; and a label holder comprising: a main body comprising a front end, a rear end, and a plurality of dividing walls, with the plurality of dividing walls defining a plurality of label slots, with each of the plurality of label slots receiving a respective label spool of the plurality of label spools, and with each dividing wall of the plurality of dividing walls defining a hanger hole, wherein the hanging hook passes through each of the hanger holes; and an orientation block projecting rearwardly from the rear end of the main body, the orientation block engaging the slotted bar of the cart.

These and other features, aspects, and advantages of the present invention will become better understood with reference to the following drawings, descriptions, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention, in use;

FIG. 2 is a perspective view of the embodiment of the present invention;

FIG. 3 is an exploded view of the embodiment of the present invention;

FIG. 4 is a section view of the embodiment of the present invention, taken along line 4-4 in FIG. 1

FIG. 5 is a section view of the embodiment of the present invention, taken along line 5-5 in FIG. 4.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

Broadly, one embodiment of the present invention is a label holder that prevents spools from coming off a hanging hook on a cart.

The present invention prevents labels from unspooling themselves, rolls of labels falling off carts, label waste, and lost productivity. The device is specifically designed for carts that include a hanging hook and C-channel bracket configured in a manner described and shown, although those with skill in the art will appreciate that small variations in cart design may be accounted for by appropriate dimensioning/design of the label holder of the present invention. The device holds the spools in such a way that they cannot fall off or unspool themselves.

Referring now to FIG. 2, a label holder is generally shown. The label holder may be formed from, for example, plastic, via a three-dimensional printing or casting process. The label holder has a main body 10 that is subdivided into a plurality of label slots (such as four) defined by dividing walls 12. The label slots are configured to receive one or more label spools 18. A front end of the label slots has an open design to facilitate the dispensing of labels from one or more label spools 18 (explained in greater detail below). Specifically, the uppermost surface of the front end of the main body 10 does not extend as high as uppermost surfaces of the dividing walls 12, resulting in the label slots having side openings. Further, bottom surfaces of the label slots may have an arcuate or semi-circular shape, as shown in FIG. 5, to position the label spools 18. A hanger hole 14 is defined in a central portion of each dividing wall 12, with all the hanger holes 14 being axially aligned with one another. An orientation block 16 projects rearwardly from an upper portion of a rear end of the main body 10.

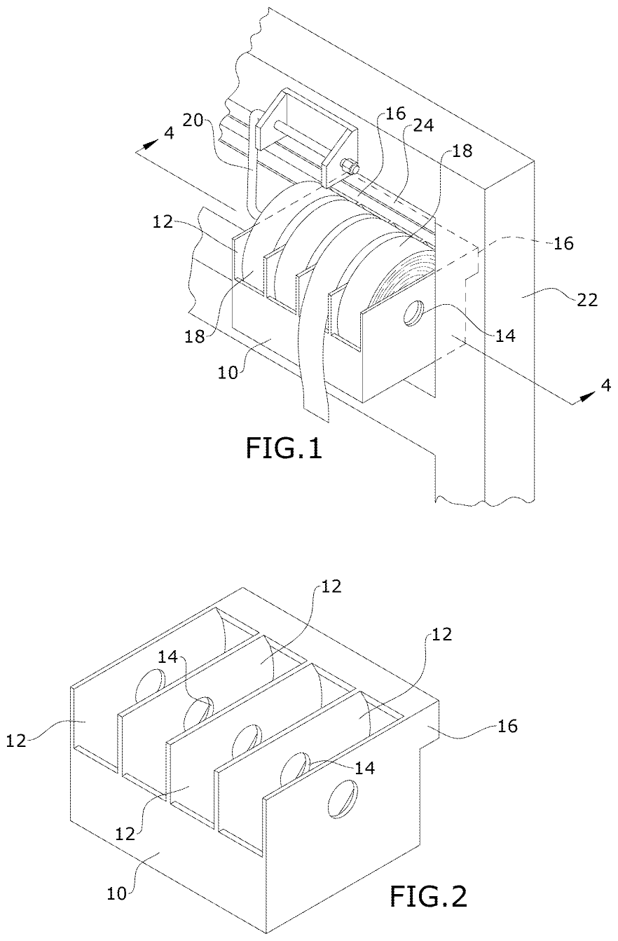

Making reference now to FIGS. 1 and 3-5, a system of the present invention further includes a cart that has a cart frame 22, a hanging hook 20 rotatably coupled to an upper end of the cart frame 22 via a bracket, and a C-channel bracket 24 (also referred to herein as a slotted bar) coupled to the cart frame 22. As shown in FIG. 5, the C-channel bracket 24 is positioned in a recess defined in the cart frame 22.

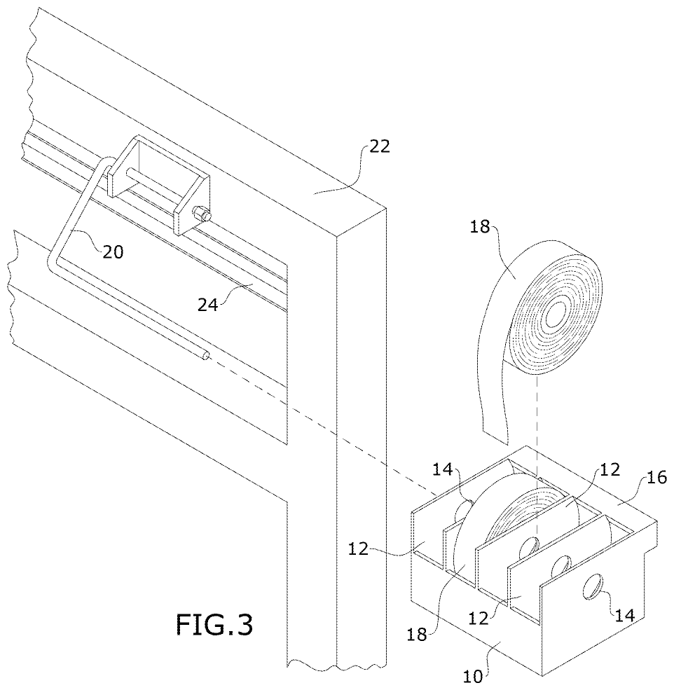

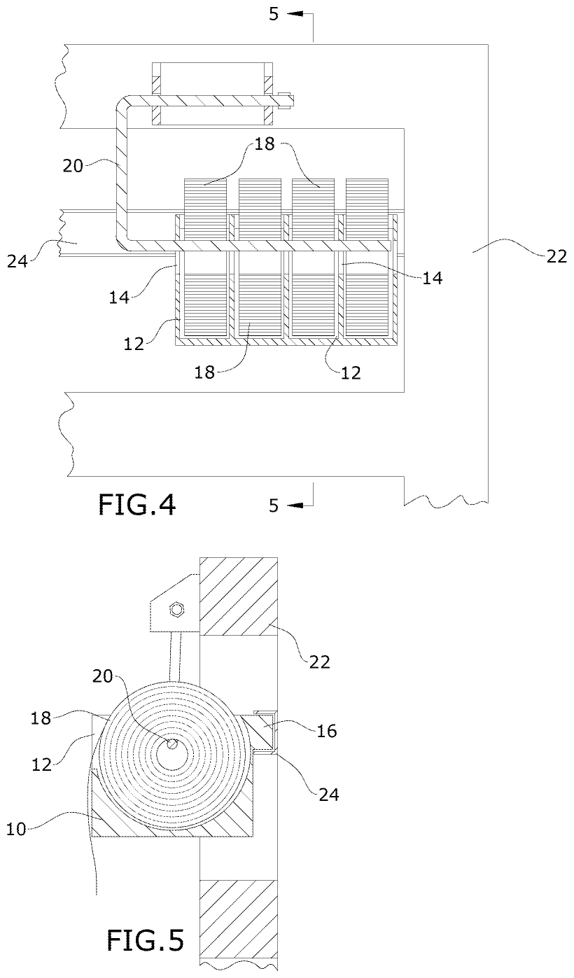

To assemble, and as shown in FIG. 3, one or more label spools 18 are inserted into the label slots of the main body 10. The arcuate lower surface of the label slots help to position the label spools 18 in a desired alignment. As a result, and as shown in FIGS. 4 and 5, the central holes of the label spools 18 align with the hanger holes 14, creating an unobstructed opening therethrough. To place the label holder on the cart, the hanging hook 20 is rotated upwardly away from the cart frame 22 (see FIG. 3), and the label holder main body 10 is slid onto the hook 20. After the label holder has been slide onto the hanging hook 20, the hanging hook is rotated downwardly which brings the orientation block into engagement with the C-channel bracket 24, as shown in FIG. 5. That engagement prevents the label holder from rotation. Further, because the label holder is partially disposed in the recess defined the cart frame 22, as shown in FIG. 1, it cannot unintentionally slide off the hanging hook 20 (due to it otherwise bumping up against a side wall of the recess, as illustrated in FIG. 4). Thus, the label holder is securely maintained in position, and labels from the various label spools 18 can reliably be dispensed. The aforementioned side openings make it easier for a user to pull the labels from the label spools 18. As those with skill in the art will appreciate, similar steps in reverse can be employed to remove and replace spools 18.

The present invention is appropriate for use in various establishments, such as, but not limited to, WALMART™ and other businesses that utilize carts with label hanging hooks similar to the presently described invention. For example, the present invention may be used in conjunction with carts utilized by WALMART™, as of the filing date of the present invention, for its online grocery department.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A label holder for a cart, the label holder comprising:
a main body comprising a front end, a rear end, and a plurality of dividing walls, with the plurality of dividing walls defining a plurality of label slots, with each of the plurality of label slots being configured to receive a label spool, and with each dividing wall of the plurality of dividing walls defining a hanger hole configured to have a cart hanging hook pass therethrough; and
an orientation block projecting rearwardly from the rear end of the main body, the orientation block being configured to engage a slotted bar of the cart.

2. The label holder of claim 1, wherein the hanger holes are axially aligned.

3. The label holder of claim 2, wherein an uppermost surface of the main body is disposed below uppermost surfaces of each of the plurality of dividing walls.

4. The label holder of claim 3, wherein each label slot of the plurality of label slots defines an arcuate bottom surface.

5. A label holder system comprising:
a cart comprising a cart frame, a cart hanging hook supported by the cart frame, and a slotted bar supported by the cart frame;
a plurality of label spools; and
a label holder comprising:
a main body comprising a front end, a rear end, and a plurality of dividing walls, with the plurality of dividing walls defining a plurality of label slots, with each of the plurality of label slots receiving a respective label spool of the plurality of label spools, and with each dividing wall of the plurality of dividing walls defining a hanger hole, wherein the hanging hook passes through each of the hanger holes; and
an orientation block projecting rearwardly from the rear end of the main body, the orientation block engaging the slotted bar of the cart.

6. The label holder system of claim 5, wherein the hanging hook is rotatably coupled to the cart.

7. The label holder system of claim 6, wherein the cart frame defines a recessed portion, with the slotted bar is disposed in the recessed portion, and with the label holder being at least partially disposed in the recessed portion.

8. The label holder system of claim 7, wherein the hanger holes are axially aligned.

9. The label holder system of claim 8, wherein an uppermost surface of the main body is disposed below uppermost surfaces of each of the plurality of dividing walls.

10. The label holder system of claim 9, wherein each label slot of the plurality of label slots defines an arcuate bottom surface.
